(19) United States
(12) Patent Application Publication
(10) Pub. No.: US 2003/0106968 A1
(43) Pub. Date: Jun. 12, 2003

(54) Exhaust system tool and method for use thereof

(76) Inventors: George Terrill, Gaithersburg, MD (US); James M. McDonough, East Greenwich, RI (US)

Correspondence Address: THE H.T. THAN LAW GROUP, SUTTON EXECUTIVE CENTER, 3201 NEW MEXICO AVEUE, N.W., SUITE 350, WASHINGTON, DC, 20016, US

(21) Appl. No.: 10/011,094

(22) Filed: Dec. 7, 2001

(51) Int. Cl. F16L 3/00; E21F 17/02

(52) U.S. Cl. 248/58; 248/610

(57) ABSTRACT

The present invention is directed to an exhaust system tool and a method for use thereof. The tool includes a pair of clamps connected by a coupler. The clamps are selectively openable to receive tubular members of the exhaust system. When a force is applied to the coupler, the clamps move relative to one another to separate or join the tubular members of the exhaust system.

### FIELD OF THE INVENTION

The present invention relates to a tool for car repair, and more particularly to an exhaust system repair tool and a method for use thereof.

### BACKGROUND OF THE INVENTION

Referring to FIG. 1, a motor vehicle (not shown) contains a representative engine 10 for powering the vehicle through combustion of a fuel and an exhaust system 12 for guiding the gases produced by the combustion away from the engine 10. The exhaust system 12 includes an exhaust manifold 14 connected to the engine's cylinder head and a muffler 16 downstream of the manifold 14. The muffler 16 is configured to allow the exhausted gases to exit the exhaust system quietly. The exhaust system 12 optionally includes a catalytic converter 18 for cleaning the pollutants from the burned fuel before they are exited from the system. The catalytic converter 18 is typically located between the exhaust manifold 14 and the muffler 16. The exhaust system 12 also includes a tail pipe 20 connected to a pipe element 16a at the exit end of the muffler 16. The tail pipe 20 directs the exhausted gases G from the muffler 16 into the air behind the vehicle. These components of the exhaust system 12 are joined in an overlapping fashion, such as between tail pipe 20 and pipe element 16a. Various lengths of tubular conduits 22 may also be joined to components of the exhaust system to establish a continuous path through these components. The exhaust system is supported by the under carriage of the vehicle by rings, retainers (not shown), and the likes.

During operation of the vehicle, temperature changes, moisture and cyclic stresses often result in one or more components of the exhaust system failing or developing holes. It is desirable to only replace the damaged component in the exhaust system. To that end, attempts have been made to separate the components from one another to replace only the defective part. Conventional ways of doing this include using a hammer or mallet, pneumatic devices, chisels, or cutting torches to separate the components. Prior to separating the components, one or more of the overlapping sections of the components may be heated. Often times the parts cannot be separated by these methods so that the entire exhaust system or several pieces of the system would be replaced at great cost. Just as frequently, using the above methods damages other parts of the exhaust system, which is undesirable.

Therefore, there remains a need for a tool and a method for use thereof that can easily separate and/or reassemble various components of the exhaust system and unlikely to damage the exhaust system during use.

### SUMMARY OF THE INVENTION

The present invention is directed to a tool adapted for use with an exhaust system. The tool comprises first and second selectively openable clamps configured and dimensioned to receive first and second tubular members, respectively. The tool further includes a coupler operatively connecting the first clamp to the second clamp so that when a force is applied to the coupler the first clamp moves relative to the second clamp. The movement of the first and second clamps causes the first tubular member to move relative to the second tubular member.

According to one feature of one embodiment of the present invention, each clamp applies a compressive force on the associated tubular member. According to one feature of one embodiment of the present invention, the first clamp is stationary during application of the force and the second clamp moves relative to the first clamp.

Preferably, the tool is removed from exhaust system, when a vehicle is driven.

In one embodiment, the first and second clamps move to separate the first and second tubular members from a joined state.

The present invention is also directed to a tool for separating and/or joining tubular components of a vehicle exhaust system. The tool comprises a pair of clamps and a pair of threaded members. Each clamp includes a base that defines a first cradle and a closure that defines a second cradle. The closure is selectively connectable to the base so that in an attached position the first and second cradles are positioned around a tubular member. The pair of threaded members are connected to the base of each clamp on opposite sides of each first cradle. The threaded members are also connected to the base spaced from the closure of each clamp. Upon applying a force to the pair of threaded members, the clamps move with respect to one another to separate and/or join the tubular members therein.

In one embodiment, one clamp is a stationary clamp and connected to the pair of threaded members, such that the stationary clamp is linearly stationary with respect to the threaded members, and the other clamp is connected to the threaded members, such that the other clamp is linearly movable with respect to the threaded members. As a result, upon applying the force the stationary clamp remains in an initial position, and the movable clamp moves along the pair of threaded members.

According to one aspect of the present invention, the base further includes a central portion with the first cradle, and tabs extending outwardly from the central portion. The tabs may define bores for receiving each of the threaded members.

According to another embodiment, the tool further includes at least one insert selectively disposable between the first and second cradles and the tubular member. Alternatively, the tool may include a set of inserts with different sizes so that the tool can be used with tubular members of various diameters.

The tool of the present invention may alternatively be sized and dimensioned for use with non-circular tubular members, such as oval, polygonal tubes. Furthermore, the tool may be sized and dimensioned for use with circular tubular members and include inserts that have circular outer surfaces and non-circular inner surfaces to use with non-circular tubular members.

According to another embodiment, the present invention is a tool comprising a pair of clamps and a coupler operatively connecting the clamps. Each clamp includes a base defining a first cradle and a closure defining a second cradle. The closure is selectively connectable to the base so that in an attached position the first and second cradles are positioned around a tubular member. The first cradle has a first arc length, and the second cradle has a second arc length different from the first arc length. Upon applying a force to the coupler, the clamps move relative to one another.

The present invention is also directed to a method of using a tool on an exhaust system of an engine, which may be mounted to a vehicle. The method includes providing an exhaust system releasably connected to the vehicle. The exhaust system includes a first tubular member and a second tubular member. The method further includes providing a tool. The tool includes a selectively openable first clamp, a selectively openable second clamp, and at least one coupler operatively associating the first clamp to the second clamp. The coupler is preferably structurally connected to the tool. On the other hand, the coupler may be provided separately therefrom and functionally connected to the tool. In addition, the method includes securing the first tubular member in the first clamp, securing the second tubular member in the second clamp, and applying a force to the coupler. The force moves the first and second clamps with respect to one another and moves the associated first and second tubular members with respect to one another.

According to one embodiment of the method, the step of providing the exhaust system further comprises providing the first and second tubular members in a joined state and the step of applying the force further includes separating the first and second tubular members. Alternatively, the step of providing the exhaust system further comprises providing the first and second tubular members in a spaced apart state and the step of applying the force further includes joining the first and second tubular members.

According to one feature of the method, the step of applying the force further includes rotating a tool, such as a wrench, a torque arm or the likes, connected to the at least one coupler. According to another feature, the step of applying the force further includes activating a hydraulic source connected to the at least one coupler, activating a pneumatic source connected to the at least one coupler, or applying mechanical linkages to the at least one coupler.

According to another feature of the method, in the step of providing the exhaust system the first tubular member may be part of a muffler. Furthermore, in the step of providing the exhaust system the second tubular member may be part of a tail pipe. The present method is not limited to these parts, and can be used to join and/or separate other components of the exhaust system (e.g., manifold, conduits, catalytic converter, and muffler) from one another, or join and/or separate the exhaust system from the engine.

### BRIEF DESCRIPTION OF THE DRAWINGS

In the accompanying drawings which form a part of the specification and are to be read in conjunction therewith and in which like reference numerals are used to indicate like parts in the various views:

FIG. 1 is a perspective view of a prior art engine and exhaust system for use with a tool and method of the present invention;

FIG. 2 is a perspective view of a first embodiment of the tool of the present invention;

FIG. 3 is a front view of a first clamp of the tool of FIG. 2, wherein a plurality of inserts are installed;

FIG. 3A is a cross-sectional view of the first clamp of FIG. 3 with inserts along the lines 3A-3A;

FIG. 3B is a cross-sectional view of an alternative configuration of the first clamp and inserts of FIG. 3A;

FIG. 4 is a top view of the tool of FIG. 2 with a tail pipe connected to a pipe element of a muffler installed therein;

FIG. 5 is a perspective view of a second embodiment of the tool of the present invention;

FIG. 6 is a perspective view of a third embodiment of the tool of the present invention; and

FIG. 7 is a perspective view of a fourth embodiment of the tool of the present invention.

### DETAILED DESCRIPTION OF THE INVENTION

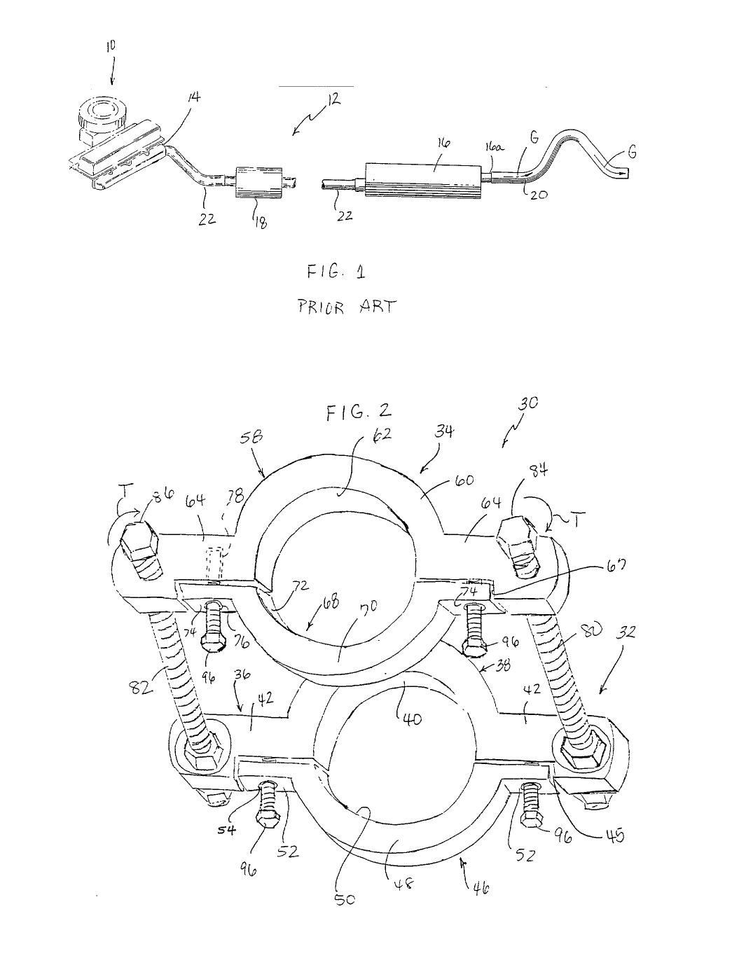

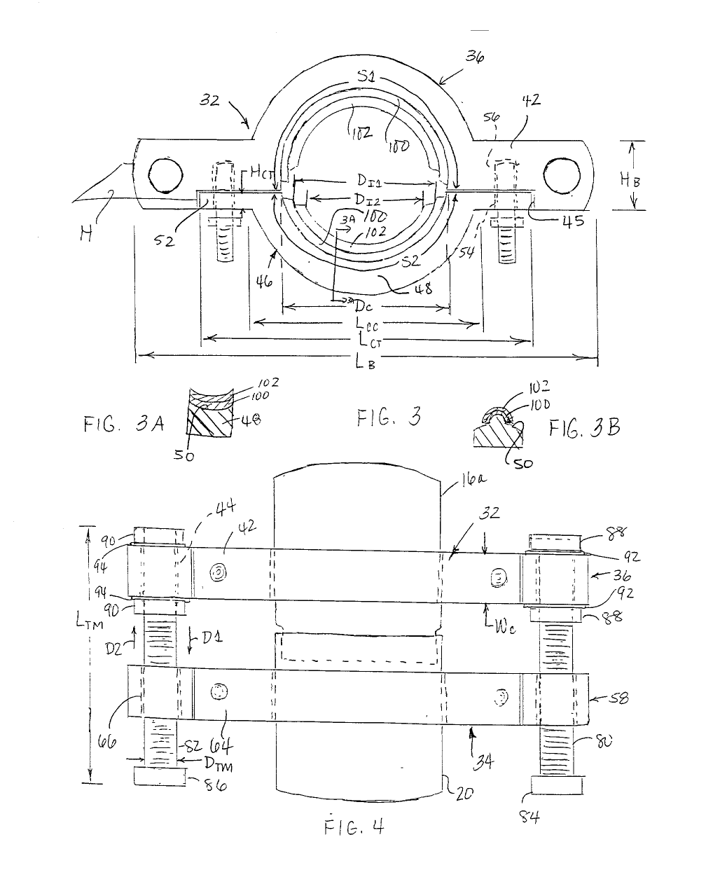

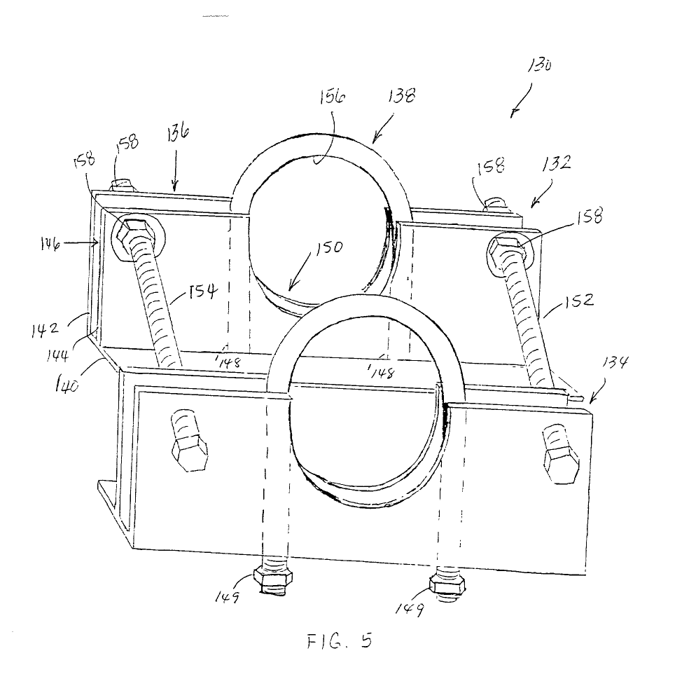

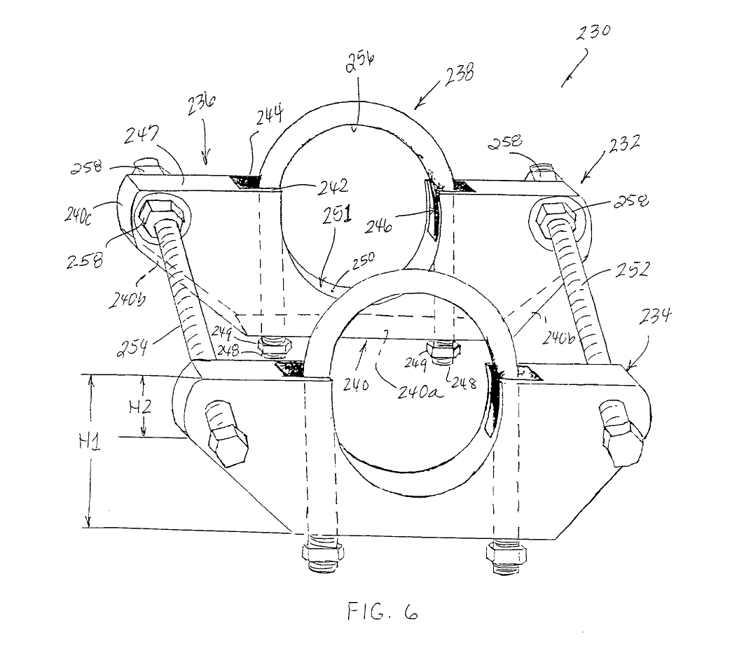

In FIGS. 2-3 where like numbers designate like parts, reference number 30 broadly designates a tool of the present invention. The tool 30 includes a pair of clamps 32 and 34. Preferably, the first clamp 32 is stationary and the second clamp 34 is movable, as described below. The first clamp 32 includes a base 36 that includes a central portion 38 with a first arcuate cradle 40 and a pair of outwardly extending tabs 42. Each tab 42 defines a bore 44, as best seen in FIGS. 3 and 4. This bore 44 is preferably unthreaded, but the present invention is not limited thereto. Referring to FIGS. 2 and 3, each tab 42 further includes a notch 45.

Referring again to FIG. 2, the first clamp 32 further includes a closure 46 that includes a central portion 48 with a second arcuate cradle 50 and a pair of outwardly extending tabs 52. The base 36 and closure 46 are configured and dimensioned so that when the closure 46 is selectively connected to the base 36, the notches 45 receive the tabs 52 of closure 46, and the cradles 40 and 50 are positioned around an entire tubular member, such as pipe member 16a, as shown in FIG. 4. Each tab 52 defines a bore 54, as best seen in FIGS. 2 and 3. Each tab 42 further includes a threaded bore 56 configured and dimensioned to be aligned with each bore 54, when the closure 46 is in an attached position.

Referring again to FIG. 2, the second clamp 34 includes a base 58 that includes a central portion 60 with a first arcuate cradle 62 and a pair of outwardly extending tabs 64. Each tab 64 defines a bore 66, as best seen in FIG. 4. This bore 66 is preferably threaded. Referring to FIG. 2, each tab 64 further includes a notch 67.

The second clamp 34 further includes a closure 68 that includes a central portion 70 with a second arcuate cradle 72 and a pair of outwardly extending tabs 74. The base 58 and closure 68 are configured and dimensioned so that when the closure 68 is selectively connected to the base 58, the notches 67 receive the tabs 74 of closure 68, and the cradles 62 and 72 are positioned around an entire tubular member, such as tail pipe 20, as shown in FIG. 4. In an alternative embodiment, the clamps can be configured to be position around a portion of each tubular member. Referring again to FIG. 2, each tab 74 of closure 68 defines a bore 76. Each tab 64 of base 58 further includes a threaded bore 78 configured and dimensioned to be aligned with each bore 76 when the closure 68 is in an attached position.

The tool 30 can be formed of metal, a metal alloy, certain polymers or any combination thereof. Preferred materials include steel, aluminum, iron, plastics, composites of plastic and metal or resin/fiber materials. The material used will determine the geometry and dimensions of the features of the tool. The preferred exemplary dimensions for the first clamp 32 made from cast and/or machined metals are as follows. Referring again to FIG. 3, the length of the base 36, which is designated L_{B}, is about seven inches. The height of the base tabs 42, which is designated H_{B}, is about 1 inch. As shown in FIG. 4, the width of the clamp 32, which is designated W_{C}, is about 0.75 inches. Referring again to FIG. 3, the total closure length, which is designated L_{CT}, is about five inches. The length of the central portion 48 of the closure 46, which is designated L_{CC}, is about 3.5 inches. The diameter of the cradle, which is designated D_{C}, is about 2.5 inches. Although discussed above in terms of diameter, the cradle may be described by radius. The height of the closure tabs 52, which is designated H_{CT}, is about 0.25 inches. As shown in FIG. 2, second clamp 34 has similar dimensions as first clamp 32.

Referring to FIGS. 2 and 3, the first cradle 40 has a first arc length S1 and the second cradle 50 has a second arc length S2. The first arc length S1 is preferably greater than the second arc length S2, which illustrates that the base and closure are asymmetrical with respect to a horizontal plane H.

Referring again to FIGS. 2 and 4, the tool 30 further includes a coupler operatively associating the first clamp 32 with the second clamp 34. In this embodiment, the coupler is a pair of threaded members 80 and 82 connected to only the base 36 of the first clamp 32 via the bores 44 in tabs 42. As a result, the threaded members 80 and 82 are spaced from the closure 46. In an alternative embodiment, the coupler can be a single threaded member or more than two threaded members, or other mechanisms. Preferably, the first clamp 32 is non-movable linearly with respect to the threaded members 80 and 82, and the second clamp 34 is movable linearly with respect to the threaded members 80 and 82. The threaded members 80 and 82 are only connected to the base 58 of the second clamp 34 via the bores 66 in tabs 64. As a result, the threaded members 80 and 82 are spaced from closure 68. Each of the threaded members 80 and 82 include a bolt head 84 and 86, respectively at each free end. In the present embodiment, the length of the threaded members 80 and 82, which is designated L_{TM}, may range from about 7 inches to about 9 inches. The diameter of the rod portion of the threaded members 80 and 82, which is designated D_{TM}, is about 0.5 inch or more. The present invention is not limited to these dimensions.

Each of the threaded members 80 and 82 receives pairs of nuts 88 and 90, respectively. Base 36 is located between the nuts 88 and between the nuts 90, as shown in FIG. 4. As a result of this configuration, the base 36 cannot move along the length of the threaded members 80 and 82. The tool 30 further optionally includes a set of washers 92 located between the nuts 88 and base 36 and optionally includes a set of washers 94 located between nuts 90 and base 36.

Referring to FIGS. 2 and 3, the clamps 32 and 34 can be preferably fitted with a one or more inserts 100 and 102. The insert can allow the same tool to be used on pipes of various diameters. The diameter of the first insert 100, which is designated D_{I1}, is about 2.25 inches. The diameter of the second insert 102, which is designated D_{I2}, is about 2 inches. In one embodiment, the tool can be offered in an automotive embodiment with a series of inserts to fit pipes with diameters from about 1.875 inches to about 2.5 inches. In another embodiment, the tool can be offered in a truck embodiment with a series of inserts to fit pipes with diameters from about 2.75 inches to about 3.5 inches. The inserts can be formed of metal, metal alloys, plastics, elastomeric material, composites, or the like. The inserts may be described by diameter or radius. The present invention is not limited to these dimensions. The inserts can be releasably secured to the clamps for ease of use with fasteners, adhesive or the like.

As shown in FIG. 3A, the surface of the cradle 50 of the first clamp 32 (see FIG. 2) may be bowed. The cradles 40, 62 and 72 (see FIG. 2) can be similarly shaped. The inserts 100 and 102, as best seen in FIG. 3A, can also be bow-shaped to conform to the shape of the cradle. Alternatively as shown in FIG. 3B, the surface of the cradle 50 can include a central projection for retaining the inserts 100 and 102. The cradles 40, 62 and 72 (see FIG. 2) can be similarly shaped.

The tool of the present invention may alternatively be sized and dimensioned for use with non-circular tubular members, such as oval, polygonal tubes, among others. Furthermore, the tool may be sized and dimensioned for use with circular tubular members and include inserts that have circular outer surfaces to match with the tool and non-circular inner surfaces to match with non-circular tubular members.

Referring to FIGS. 1-4, the method for using the tool 30 on a vehicle will now be discussed. An exhaust system 12 is provided which is releasably connected to the vehicle. Depending on the components of the exhaust system 12 to be repaired or replaced, the exhaust system 12 may need to be detached or loosened from the undercarriage of the vehicle, but the system need not be completely separated from the vehicle. The tool 30 is then provided and the first and second clamps 32 and 34 are opened. If necessary, inserts 100 and 102 can be placed within the clamps 32 and 34. The first and second cradles 40 and 62 of each clamp are preferably located above each tubular member such as 16a and 20. If inserts are not used, the cradles contact the tubular members. If inserts are used, the outermost insert contacts the tubular members. Then, clamp 32 is closed by selectively attaching or securing closure 46 to base 36 by extending threaded fasteners 96 into and through bores 54, 56 in clamp 32. Clamp 34 is also closed by securing closure 68 to base 58 by extending threaded fasteners 96 into and through bores 76, 78 in clamp 34. The fasteners 96 are tightened until the clamps 32 and 34 or inserts securely contact the tubular members 16a and 20 and apply a compressive force thereon. The compressive force should be sufficient to prevent slippage of the clamps with respect to the tubular members, such as 16a and 20. The compressive force can be empirically and/or theoretically determined.

Referring to FIG. 2, next a rotational force or a torque designated by the arrow T is applied to the bolt ends 84 and 86 of threaded members 80 and 82. Force T causes the threaded members 80 and 82 to rotate and depending on the direction of the force causes the second clamp 34 to move in a direction D1 or in an opposite direction D2, as shown in FIG. 4. When second clamp 34 moves, first clamp 32 remains stationary due to the positions of bolts 88 and 90 relative to the first clamp 32 so that the second clamp 34 moves with respect to the first clamp 32. Force T is translated to the tubular exhaust members 16a and 20 through the arcuate cradles 40 and 50 and 62 and 72, respectively so that the exhaust members 16a and 20 also move with respect to one another. If the clamp 34 moves in the direction D1, the members 16a and 20 can be moved from an initially joined state to a separated state. If the clamp 34 moves in the direction D2, the members 16a and 20 can be moved from an initially separated state to a joined state. After the components 16a and 20 are separated, the defective or damaged part(s) can be repaired or replaced and installed into the exhaust system. Force T can be applied by a variety of tools such as manually using or rotating a wrench or ratcheting mechanism. Alternatively the force can be applied automatically using an air gun connected to a hydraulic source or automatically using a pneumatic source. The force T can be empirically and/or theoretically determined, and should be sufficient to assemble or separate tubular members such as 16a and 20. Once the defective part is repaired or replaced in the exhaust system, the exhaust system can be reconnected to the vehicle. The present tool can also be used to separate parts of the exhaust system so that other systems of the vehicle, such as the transmission or gas lines, can be serviced. In this case, the exhaust system may not be in need of repair.

Referring to FIG. 5, an alternative embodiment of a tool 130 is shown. The tool 130 includes a first clamp 132 and a second clamp 134. The first clamp 132 includes a base 136 and a closure 138. The base 136 includes first wall 140 and a second upstanding wall 142 connected substantially perpendicular to the first wall 140 and extending upwardly therefrom. The base 136 further optionally includes a third upstanding wall 144 connected substantially perpendicular to the first wall 140 and extending upwardly therefrom. The third wall 144 is spaced from the second wall 142 to form a gap 146 therebetween. The first wall 140 includes two bores, bolt holes or through holes (not shown) for receiving the threaded free ends 148 of the closure 138. The free ends 148 of the closure 138 receive nutsl49. The second and third walls 142 and 144 define a first arcuate cradle 150 and include bores (not shown) for receiving threaded members 152 and 154.

The closure 138 is a U-shaped bolt that defines a second cradle 156. The second clamp 134 is configured similarly to first clamp 132. The tool 130 further includes nuts 158 similar to tool 30 to prevent liner movement of the first clamp 132 relative to threaded members 152 and 154. On the other hand, second clamp 134 is linearly movable relative to threaded members 152 and 154. The tool 130 is used similarly to tool 30 to separate and/or join tubular members of an exhaust system. However, the cradle 156 of closure 138 can be located above the tubular exhaust member during use. The tool 130 can be used with inserts as described above or with different sized U-bolts.

Preferably, the walls 140, 142 and 144 are made from a single block of material, and the spaces separating the walls are milled from the block to form the walls. Alternatively, the walls 140, 142, and 144 are formed of separate pieces of iron and welded together. In another embodiment, the walls 140, 142, and 144 can be formed of a different material and a different construction method. In an alternative embodiment, the geometry of the bases can be modified as dictated by the material properties of the selected material among other considerations.

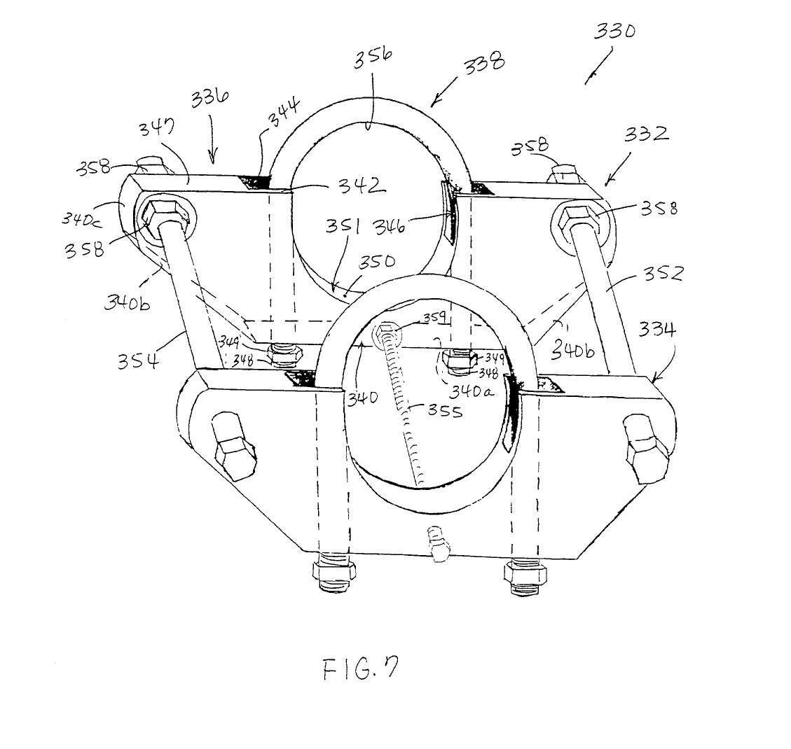

Referring to FIG. 6, an alternative embodiment of a tool 230 is shown. The tool 230 includes a first clamp 232 and a second clamp 234. The first clamp 232 includes a base 236 and a closure 238. The base 236 includes first wall 240 with a central portion 240a, two upwardly angled portions 240b and curved portions 240c. The base 236 also includes a second upstanding wall 242 connected substantially perpendicular to the first wall 240. The base 236 further includes a third upstanding wall 244 connected substantially perpendicular to the first wall 240. The third wall 244 is spaced from the second wall 242 to form a gap 246 therebetween. The base also includes a fourth wall 247 for joining the upper ends of the second and third upstanding walls 242 and 244.

The central portion 240a of first wall 240 includes two bores or bolt holes (not shown) for receiving threaded free ends 248 of the closure 238. The free ends 248 of the closure 238 receive nuts 249. A fifth wall 250 of base 236 joining the second and third walls 242 and 244 defines a first arcuate cradle 251. Second and third walls 242 and 244 include bores (not shown) for receiving threaded members 252 and 254.

The closure 238 is a U-shaped bolt that defines a second cradle 256. The second clamp 234 is configured similarly to first clamp 232. The tool 230 further includes nuts 258 similar to tool 30 to prevent linear movement of the first clamp 232 relative to threaded members 252 and 254. The tool 230 is used similarly to tool 30 to separate and/or join tubular members of an exhaust system. However, the cradle 256 of closure 238 can be located above the tubular exhaust member during use. The tool 230 can be used with inserts as described above or with different sized U-bolts.

Preferably, the walls 240, 242, 244, 247, and 250 of the base 236 are formed of a single molded plastic piece or machined from a single piece of metal. However, in another embodiment, the base can be formed of a different material such as metal or a metal alloy using a different construction method such as welding. In this embodiment, the base 236 has a first height H1 and a second height H2 less than the first height H1. In an alternative embodiment, the geometry of the base can be modified as dictated by the material properties of the selected material among other considerations for proper load bearing.

Referring to FIG. 7, an alternative embodiment of a tool 330 is shown. The tool 330 includes a first clamp 332 and a second clamp 334. The first clamp 332 includes a base 336 and a closure 338. The base 336 includes first wall 340 with a central portion 340a, two upwardly angled portions 340b and curved portions 340c. The base 336 also includes a second upstanding wall 342 connected substantially perpendicular to the first wall 340. The base 336 further includes a third upstanding wall 344 connected substantially perpendicular to the first wall 340. The third wall 344 is spaced from the second wall 342 to form a gap 346 therebetween. The base 336 also includes a fourth wall 347 for joining the upper ends of the second and third upstanding walls 342 and 344.

The central portion 340a of first wall 340 includes two bores or bolt holes (not shown) for receiving threaded free ends 348 of the closure 338. The free ends 348 of the closure 338 receive nuts 349. A fifth wall 350 of base 336 joining the second and third walls 342 and 344 defines a first arcuate cradle 351. Second and third walls 342 and 344 include bores (not shown) for receiving guide members 352 and 354 and a single threaded member 355. The guide members 352 and 354 are unthreaded. The number and location of guide members 352 and 354 and threaded member 355 can be modified.

The closure 338 is a U-shaped bolt that defines a second cradle 356. The second clamp 334 is configured similarly to first clamp 332. The tool 330 further includes nuts 358 on guide members 352 and 354 similar to tool 30 to prevent linear movement of the first clamp 332 relative to guide members 352 and 354. The nuts 358 are optional and the number of nuts 358 can be varied. The tool 330 also includes a pair of nuts 359 on threaded member 355 sandwiched about clamp 332 to prevent linear movement of the first clamp 332 relative to threaded member 355. The tool 330 is used similarly to tool 30 to separate and/or join tubular members of an exhaust system by applying a force to threaded member 355. However, the cradle 356 of closure 338 can be located above the tubular exhaust member during use. The tool 330 can be used with inserts as described above or with different sized U-bolts.

Preferably, the walls 340, 342, 344, 347, and 350 of the base 336 are formed of a single molded plastic piece or machined from a single piece of metal. However, in another embodiment, the base can be formed of a different material such as metal or a metal alloy using a different construction method such as welding. The geometry of the base can be modified as dictated by the material properties of the selected material among other considerations for proper load bearing. A preferred metal for the embodiments discussed above is 1080 cold rolled steel with a protective coating such as zinc or chrome plating. Another preferred metal is carbon steel 1018. Any other metals with similar properties to these preferred metals can be used.

While various descriptions of the present invention are described above, it is understood that the various features of the present invention can be modified. For example, in the present invention, the coupler can be changed from the threaded members to include a central hexagonal section for applying the force thereto or the threaded members can include a knob, lever or the like for applying force thereto. In addition, the closures can be connected to the bases using elements other than threaded fasteners, such as additional clamps, snap-on fasteners, cotter keys or the like. Additionally, the first and second clamps of the tool can be operatively connected by members that include pneumatic, hydraulic, mechanical linkages or electrically powered movable elements. For example, these elements can be slidably connected with the power source therebetween to separate or join the elements. In all of the embodiments, the geometry of the bases and closures can be modified as dictated by the material properties of the selected material among other considerations. In an alternative embodiment, the tools can be modified so that both clamps move relative to one another to separate and/or join components of the exhaust system. In the embodiments above, the coupler is structurally connected to the clamps or structurally connects the clamps together. In an alternative embodiment, the coupler can be separate from the clamps so that the coupler functionally connects the clamps together. In such an example, the coupler can be a device separate from the clamps with members for retaining the clamps and moving them relative to one another. The present invention can be used on various exhaust systems such as those in vehicles or those in other non-vehicle applications, such as those used in stationary power generation systems with engines. In yet another alternative embodiment, any of the embodiments can be modified to include any of the features of other embodiments singly or in combination. Therefore this invention is not to be limited to the specifically preferred embodiments depicted therein.

We claim:

1. A tool adapted for use with an exhaust system comprising:
a first selectively openable clamp configured and dimensioned to receive a first tubular member of the exhaust system;
a second selectively openable clamp configured and dimensioned to receive a second tubular member of the exhaust system;
a coupler operatively connecting the first clamp to the second clamp so that when a force is applied to the coupler the first clamp moves relative to the second clamp and the movement of the first and second clamps causes the first tubular member to move relative to the second tubular member.

2. The tool of claim 1, wherein each clamp applies a compressive force on the associated tubular member.

3. The tool of claim 1, wherein the first clamp is stationary during application of the force and the second clamp moves relative to the first clamp.

4. The tool of claim 1, wherein the exhaust system is connected to a vehicle and the tool is removed from the exhaust system before the vehicle is driven.

5. The tool of claim 1, wherein the first and second clamps move to separate the first and second tubular members from a joined state.

6. A tool comprising:
a pair of clamps, each clamp including
a base defining a first cradle;
a closure defining a second cradle and selectively connectable to the base so that in an attached position the first and second cradles are positioned around an associated tubular member;
a pair of threaded members connected to the base of each clamp on opposite sides of each first cradle, and the pair of threaded members being connected spaced from the closure,
wherein upon applying a force to the pair of threaded members the clamps move with respect to one another.

7. The tool of claim 6, wherein one clamp is a stationary clamp linearly fixedly connected to the pair of threaded members, so that upon applying the force the stationary clamp remains in an initial position, and the other clamp is a movable clamp linearly movably connected to the pair of threaded members, so that upon applying the force the movable clamp moves along the pair of threaded members.

8. The tool of claim 6, wherein the base further includes a central portion with the first cradle and tabs extending outwardly from the central portion, the tabs define bores for receiving each of the threaded members.

9. The tool of claim 6, wherein the base further includes a first wall and second wall connected substantially perpendicular to the first wall, the first wall including a pair of spaced apart through holes, and the closure is a U-shaped bolt with two threaded free ends for extending through the through holes.

10. The tool of claim 9, wherein the base further includes a third wall connected substantially perpendicular to the first wall and spaced from the second wall to define a gap for receiving the U-shaped bolt.

11. The tool of claim 6, wherein each closure is selectively joined to the associated base.

12. The tool of claim 6, wherein the first cradle has a first arc length and the second cradle has a second arc length, and the first arc length is greater than the second arc length.

13. The tool of claim 6, further including at least one insert being selectively disposable between the first and second cradles and each tubular member.

14. The tool of claim 13, further including a set of inserts with different sizes so that the tool can be used with tubular members of various sizes.

15. The tool of claim 13, further including non-circular inserts so that the tool can be used with non-circular tubular members.

16. A tool comprising:
a pair of clamps, each clamp including
a base defining a first cradle having a first arc length;
a closure defining a second cradle and selectively connectable to the base so that in an attached position the first and second cradles positioned around an associated tubular member, the second cradle having a second arc length different from the first arc length; and
a coupler operatively connecting the clamps,
wherein upon applying a force to the coupler the clamps move relative to one another.

17. The tool of claim 16, wherein the clamps are structurally connected by the coupler.

18. The tool of claim 16, wherein the clamps are functionally connected by the coupler.

19. A method of using a tool on a vehicle comprising:
providing an exhaust system releasably connected to the vehicle, the exhaust system including a first tubular member and a second tubular member;
providing a tool including a selectively openable first clamp, a selectively openable second clamp, and at least one coupler operatively associating the first and second clamps;
securing the first tubular member in the first clamp;
securing the second tubular member in the second clamp; and
applying a force to the at least one coupler to move the first and second clamps with respect to one another and to move the associated first and second tubular members with respect to one another.

20. The method of claim 19, wherein the step of providing the exhaust system further comprises providing the first and second tubular members in a joined state and the step of applying the force further includes separating the first and second tubular members.

21. The method of claim 19, wherein the step of providing the exhaust system further comprising providing the first and second tubular members in a spaced apart state and the step of applying the force further includes joining the first and second tubular members.

22. The method of claim 19, wherein the step of applying the force further includes rotating a tool connected to the at least one coupler.

23. The method of claim 19, wherein the step of applying the force further includes activating a hydraulic source connected to the at least one coupler.

24. The method of claim 19, wherein the step of applying the fore further includes activating a pneumatic source connected to the at least one coupler.

25. The method of claim 19, wherein the step of applying the force further includes applying mechanical linkages connected to the at lease one coupler.

26. The method of claim 19, wherein the step of applying the force further includes activating electrically powered movable elements connected to the at lease one coupler.

27. The method of claim 19, wherein the step of providing the exhaust system further comprises detaching the exhaust system from the vehicle before securing the first and second tubular members in the first and second clamps.

28. The method of claim 19, wherein in the step of providing the exhaust system the first tubular member is part of a muffler.

29. The method of claim 28, wherein in the step of providing the exhaust system the second tubular member is part of a tail pipe.

30. The method of claim 19, wherein in the step of providing the coupler includes providing a coupler structurally connects the clamps of the tool.

31. The method of claim 19, wherein in the step of providing the coupler includes providing a coupler functionally connects the clamps of the tool.
